(19) United States
(12) Patent Application Publication
(10) Pub. No.: US 2010/0145798 A1
(43) Pub. Date: Jun. 10, 2010

(54) Method for Targeting Pharmaceutical Advertisements to Customers

(76) Inventor: Paul A. Richards, Scarsdale, NY (US)

Correspondence Address: FAY KAPLUN & MARCIN, LLP, 150 BROADWAY, SUITE 702, NEW YORK, NY, 10038, US

(21) Appl. No.: 12/476,310

(22) Filed: Jun. 2, 2009

Related U.S. Application Data
(60) Provisional application No. 61/058,100, filed on Jun. 2, 2008.

(51) Int. Cl. G06Q 30/00; B65D 83/04; G06Q 90/00

(52) U.S. Cl. 705/14.49; 206/534; 705/500

(57) ABSTRACT

A promotional arrangement comprises a pharmaceutical product container having first and second compartments, wherein the first compartment comprises a first temporary sealing arrangement located adjacent an open end thereof, the first compartment being sized and shaped to receive a predetermined pharmaceutical product therein, wherein the first compartment is formed of an opaque material. A second compartment of the present invention is formed on a first lateral side of the first compartment and is sized and shaped to slidably receive a promotional item therein, wherein the second compartment comprises a transparent outer wall, the promotional item corresponding to the predetermined pharmaceutical product

### PRIORITY CLAIM

The present application claims priority to U.S. Provisional Application Ser. No. 61/058,100 filed on Jun. 2, 2008 entitled “Method for Targeting Pharmaceutical Advertisements to Customers” to Paul A. Richards.

### BACKGROUND

In 1997, the Food and Drug Administration lifted marketing regulations on pharmaceutical advertising. Since that time, pharmaceutical companies have spent billions of dollars in direct-to-consumer (DTC) advertising such as television and radio commercials, print ads, banner ads on websites, etc. However, these forms of the DTC advertising predominantly reach individuals aged 18-49, which account for approximately a quarter of the prescription drug use market. That is, individuals aged 50 and older account for a greater portion of the market because they typically are taking several prescription drugs daily. However, due to government healthcare privacy regulations (e.g., HIPAA), the pharmaceutical companies are denied personal information for individuals, making targeted marketing very difficult. Thus, there is a need for a method for targeting pharmaceutical advertisements to predefined demographic and healthcare groups.

### SUMMARY OF THE INVENTION

The present invention is directed to a promotional arrangement, comprising a pharmaceutical product container having first and second compartments, wherein the first compartment comprises a first temporary sealing arrangement located adjacent an open end thereof, the first compartment being sized and shaped to receive a predetermined pharmaceutical product therein, wherein the first compartment is formed of an opaque material. The present invention also comprises a promotional item corresponding to the predetermined pharmaceutical product. The second compartment of the present invention is formed on a first lateral side of the first compartment and is sized and shaped to slidably receive the promotional item therein, wherein the second compartment comprises a transparent outer wall.

An exemplary method according to the present invention comprises the steps of providing a plurality of pre-assembled pharmaceutical promotional arrangements, wherein the arrangements comprise a container having a first portion configured to receive a predetermined pharmaceutical product and a second portion slidably housing a promotional item corresponding to the predetermined pharmaceutical product, providing the plurality of pre-assembled pharmaceutical promotional arrangements to a user, receiving a prescription corresponding to at least one indicator of the promotional arrangement, and placing the prescribed pharmaceutical product into the promotional arrangement

### BRIEF DESCRIPTION OF THE DRAWINGS

FIG. 1 shows a perspective view of a first exemplary embodiment of an apparatus for product promotion according to the present invention;

FIG. 2 shows a partial cross-sectional lateral view of a product according to a second exemplary embodiment of the present invention;

FIG. 3 shows a partial cross-sectional lateral view of a product according to a third exemplary embodiment of the present invention; and

FIG. 4 shows an exemplary embodiment of a method for product promotion according to the present invention.

### DETAILED DESCRIPTION

The present invention may be further understood with reference to the following description and the attached drawings, wherein like elements are referred to with the same reference numerals. The exemplary embodiments of the present invention describe a system and method for product promotion via a pharmaceutical delivery arrangement. Exemplary systems and methods according to the present invention provide a preassembled pharmaceutical packaging to a pharmacist, the packaging being provided with at least one marketing or promotional item corresponding to a pharmaceutical product to be provided therein. Those of skill in the art will understand that the preassembly of the marketing or promotional item within the packaging prior to delivery of the package to a pharmacy minimizes any additional effort on the part of a pharmacist when filling a patient's prescription. In accordance with a first exemplary embodiment of the present invention, a promotional item is pre-selected based on the pharmaceutical item to be dispensed in a preassembled pharmaceutical packaging and is attached to the preassembled pharmaceutical packaging that will be used to transfer the prescribed pharmaceutical item to the customer. Thus, an advertiser of the marketing or promotional item is ensured that the promotional item reaches its intended target, thus also minimizing extraneous advertising by the advertiser and reducing overall advertising costs, as will be described in greater detail hereinafter. While the exemplary embodiments of the promotional item will be described with reference to promotion of items directly related to a predetermined pharmaceutical product, those of skill in the art will understand that any service and/or consumer item may be promoted using the promotional item without deviating from the spirit and scope of the present invention. For example, the promotional item may be utilized for grocery products, books, electronic devices, video rentals, etc. It is further noted that although the present embodiments have been described with respect to pharmacists as users, users of the exemplary embodiments of the present invention may also comprise pharmacy technicians or any other personnel authorized to dispense pharmaceutical products including, but not limited to, doctors, nurses, or other employees.

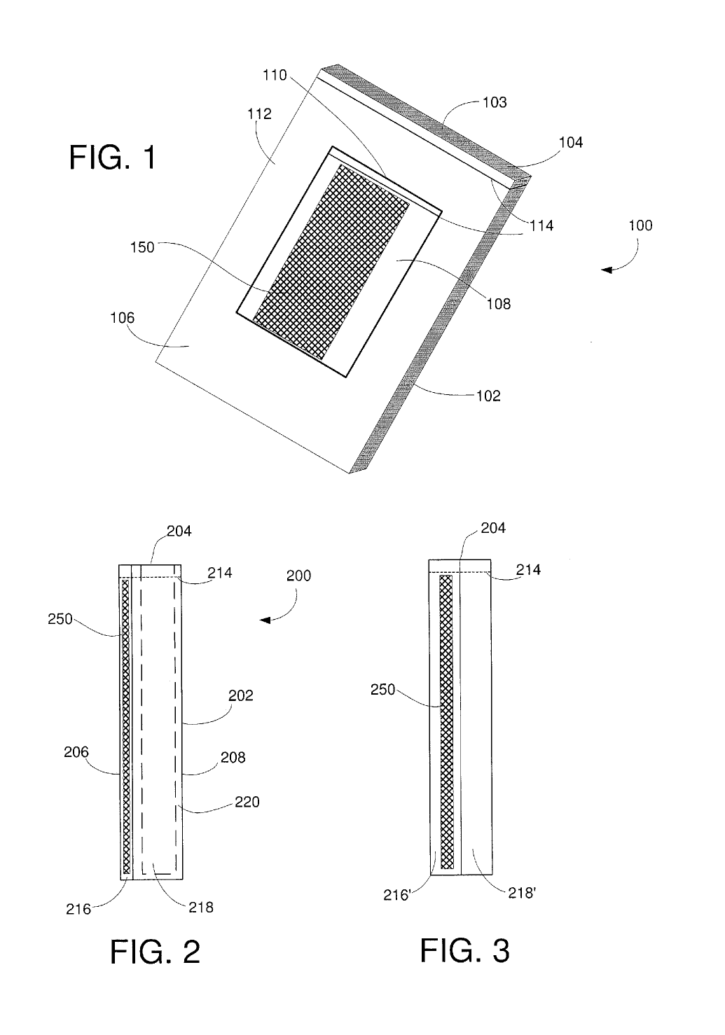

FIG. 1 depicts a system 100 according to a first exemplary embodiment of the present invention comprising a pharmaceutical delivery apparatus such as a bag 102. The bag 102 is formed with dimensions suitable to enclose a receptacle typically sized for containing a pharmaceutical product to be delivered therein. The bag 102 may conform to industry standards, as those skilled in the art will understand. Specifically, a compartment 103 of the bag 102 is sized to receive the predetermined receptacle therein. Thus, the compartment 103 does not necessarily come into direct contact with the pharmaceutical product being dispensed and may optionally hold a product receptacle such as a prescription medication bottle, envelope or another receptacle containing the pharmaceutical product. The bag 102 is formed with a substantially rectangular cross-section and may optionally include a handle (not shown) attached to an open proximal end 104 thereof. The bag 102 may be formed of a known material including one of paper and plastic or a combination of the two, as those skilled in the art will understand. The material of the bag 102 is substantially opaque to minimize or prevent visibility therethrough to maintain patient privacy. A first face 106 of the bag 102 is provided with a sleeve 108 formed of one of a substantially translucent and substantially transparent material such as a plastic. The sleeve 108 is dimensioned to permit the insertion of a target promotional item 150 therein, as will be described in greater detail hereinafter. The sleeve 108 is formed with an open end 110 permitting a slidable insertion of the promotional item 150 therein. It is noted that although the open end 110 is shown on a proximal end of the sleeve 108, the open end may optionally be provided on a lateral side of the sleeve 108 without deviating from the spirit and scope of the present invention. The sleeve 108 may be dimensioned to house the promotional item 150 therein with a substantially friction fit to maintain a proper orientation thereof within the sleeve 108 and to prevent the promotional item 150 from sliding out of the sleeve 108 during shipping. Alternatively, as will be described in greater detail hereinafter, the sleeve 108 may also comprise a seal to temporarily seal the promotional items therewithin. Furthermore, the sleeve 108 may be formed with any dimensions relative to the bag 102. In one embodiment, the sleeve 108 may be dimensioned to cover the entirety of the first face 106. The exemplary embodiment of FIG. 1 further provides a negative space 112 on which a pharmacy may print or otherwise affix a distributor trade/service mark, logo and/or slogan, sale information, legal disclaimers, etc. as necessary. Specifically, the negative space 112 is the portion of the first face 106 not covered by the sleeve 108, as shown in FIG. 1. Alternatively, the sleeve 108 itself may be printed with the aforementioned information.

The bag 102 further comprises a sealing arrangement 114 formed adjacent the free proximal end 104. The sealing arrangement 114 may be a zip seal, snap seal, adhesive or another temporary sealing arrangement known in the art, as those skilled in the art will understand. In an exemplary embodiment, a zip seal may be employed wherein a perforated portion on a first inner wall of the bag 102 may be configured to engage a respectively sized protrusion formed on an opposing inner wall of the bag 102, as those skilled in the art will understand. The exemplary sealing arrangement permits selective opening and resealing of the bag 102 without causing damage thereto. Thus, the exemplary embodiment of the present invention provides a bag 102 that can slidably receive promotional items 150 that may be removed from and reinserted into the sleeve 108 for later reference, allowing the promotional item 150 to be referenced without the risk of misplacement. The exemplary embodiment also permits a pharmacist or other user to add or remove promotional items 150 from the sleeve 108 as needed, such as, for example, the removal of expired coupons, recalled promotional items, etc. without causing any damage to the bag 102. In another embodiment of the present invention, the sleeve 108 may also be provided with a zip seal formed substantially similarly as the zip seal of the compartment 103 to prevent loss of the promotional items 150 inserted therein.

FIG. 2 depicts a lateral partial cross-sectional view of a first alternate embodiment of the present invention, wherein a system 200 comprises a bag 202 formed substantially similarly as the bag 102 of system 100. The bag 202, however, replaces the sleeve 108 with first and second compartments 216, 218. Each of the first and second compartments 216, 218 is open to a free proximal end 204 of the bag 202. The first compartment 216 is configured to receive a promotional item 250 therein and comprises a substantially translucent or transparent outer wall 206 permitting visibility of any promotional items 250 placed therein. It is further noted that the first compartment may assume any thickness relative to the second compartment 218, the thickness being selected to conform to the dimensions of at least one promotional item 250 being inserted therein. The second compartment 218 is formed with a substantially opaque outer wall 208 preventing visibility therethrough and is dimensioned to house a predetermined pharmaceutical product therein. A proximal end of the second compartment 218 is sealable via a temporary sealing arrangement 214 such as a zip seal. Those skilled in the art will understand that a zip seal is not required over a proximal end of the first compartment 216, although this feature may be added without deviating from the spirit and scope of the present invention.

The second compartment 218 may also optionally comprise insulation 220 embedded within an outer wall thereof to permit insertion of a temperature controlled pharmaceutical product therein such as, for example, insulin or another prescribed medicine that requires temperature control, as those skilled in the art will understand. Providing insulation within the bag 202, which, as described above, is pre-assembled with at least one promotional item 250 therein minimizes the steps required on the part of a pharmacist or pharmacy technician when filling a prescription.

In yet another embodiment of the present invention, as shown in the lateral partial cross-sectional view of FIG. 3, first and second compartments 216′ and 218′ may be formed with the same dimensions. Alternatively, each of the first and second compartments 216′ and 218′ may assume any dimensions suited to the promotional item 250 being inserted therein, as those skilled in the art will understand.

An exemplary promotional item to be inserted in the sleeve 108 or the first compartments 216, 216′ includes at least one of product-related data and/or graphics including, but not limited to, product information, a coupon, a rebate, a product sample, an instruction regarding the promotional item (e.g., how to detach, information contained therein, etc.), an instruction regarding the bag 102 (e.g., how to open/close, how to dispose, contents, etc.), product indications (e.g., dosages, side effects, etc.), a business reply card for soliciting additional information, manufacturer information, retailer information, a health magazine, etc. In an exemplary embodiment, the promotional item is directly related to the pharmaceutical product to be dispensed in the bag. For example, when the bag 202 is dispensed with insulin in the second compartment 218, promotional items inserted in the first compartment 216 are directly related to diabetes and may include one or more of coupons, a magazine, diabetic recipes, etc. The promotional items may also correspond to other maladies that are statistically prevalent among the diabetic population, such as, for example, fibromyalgia, depression, etc. Exemplary promotional items may also take any printed form including, but not limited to, a foldable pamphlet, an accordion style booklet, a magazine, stickers, magnets, etc. The promotional items may also include data printed in color or monochrome. In another embodiment, the promotional items may be printed in a language statistically shown to be predominant in a particular location.

The exemplary system of the present invention is directed to providing separate bags for each of a plurality of commonly prescribed products including, but not limited to diabetic drugs, anti-infective drugs, hormonal drugs, heart and circulatory drugs, allergy drugs, gastrointestinal drugs, drugs for emotional, mental and nervous conditions, etc.

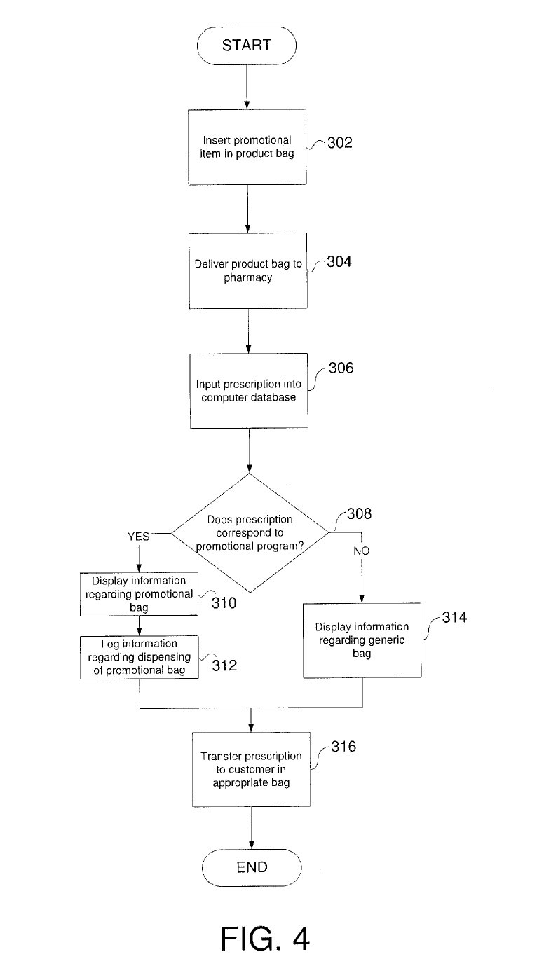

As described in greater detail with respect to FIG. 4, an exemplary method according to the present invention permits the tracking of advertisement distribution among a targeted group of recipients. Furthermore, the exemplary system and method according to the present invention provides a highly effective format of targeting consumers within a predetermined medical group, thus permitting advertisers to cater to the needs of the group.

In step 302, the bag 102 is provided with a set of promotional items within the sleeve 108, wherein the promotional items are selected to relate to the pharmaceutical product to be dispensed therein. In step 304, a plurality of bags 102 are delivered to a pharmacy ready for dispensing. In an exemplary embodiment, the bags 102 may be provided in a dispensing container or may otherwise be labeled for use only with one or more predetermined pharmaceutical products (e.g., products relating only to the treatment of Diabetes, etc.).

In step 306, a pharmacist receives a prescription order from a customer and inputs the order into a computer database. In step 308, the database determines if the prescription order requires the use of the bag 102. Specifically, the pharmacy may be provided with separate bags for individual drugs and/or conditions. Furthermore, advertisers of each of the promotional items may select their target audience (i.e., all users of a predetermined drug(s), all users within a predetermined age range, gender, race, etc.), the target audience being entered into the pharmacy computer database. The computer database comprises data relating to each of a plurality of different bags (e.g., bags 102, bags 202, etc.) for different target groups. Accordingly, when the pharmacist enters the prescription order, the computer database determines if the bag 102 or another bag (e.g., bag 202) is available for dispensing the prescribed pharmaceutical product. If a bag 102 is available for the prescribed product, the method proceeds to step 310 wherein the database displays information about the bag (e.g., a location thereof within the pharmacy, a bag product number, etc.) to the pharmacist. In step 312, the computer database may also log information regarding the dispensed bag 102 to provide this information to each of the advertisers of the promotional items contained therein. In one embodiment, this information may be provided to the advertisers at predetermined intervals (e.g., once a month, etc.). If no bag is available for the prescribed product, the method proceeds to step 314 wherein the database indicates that a generic bag is to be dispensed. The generic bag may be provided with general marketing materials that are targeted to a greater audience and may include, for example, coupons for household items, pharmacy sale information, etc. (Do you envision the use of a generic bag?) Alternatively, a standard bag without any promotional items can be used to dispense the prescribed product.

In step 316, the pharmacist enters the prescribed product in an appropriate receptacle (e.g., bottle) and inserts the receptacle in the bag 102. Alternatively, the prescribed product (e.g., insulin), which may already be provided in a receptacle is inserted directly into, for example, the second compartment 218 of bag 202, as described in greater detail earlier.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. A promotional arrangement, comprising:
a pharmaceutical product container having first and second compartments, wherein:
the first compartment comprises a first temporary sealing arrangement located adjacent an open end thereof, the first compartment being sized and shaped to receive a predetermined pharmaceutical product therein, wherein the first compartment is formed of an opaque material;
a promotional item corresponding to the predetermined pharmaceutical product; and
the second compartment is formed on a first lateral side of the first compartment and is sized and shaped to slidably receive the promotional item therein, wherein the second compartment comprises a transparent outer wall.

2. The promotional arrangement of claim 1, wherein the pharmaceutical product container is a bag.

3. The promotional arrangement of claim 1, wherein the second compartment is formed as a sleeve along the first lateral side of the first compartment.

4. The promotional arrangement of claim 1, wherein an outer wall of the first compartment is provided with insulation to control a temperature of the pharmaceutical product to be dispensed therein.

5. The promotional arrangement of claim 4, wherein the pharmaceutical product is insulin and wherein the promotional item is targeted toward Diabetics.

6. The promotional arrangement of claim 1, wherein the second compartment comprises a second temporary sealing arrangement.

7. The promotional arrangement of claim 6, wherein the first and second temporary sealing arrangements are zip seals.

8. The promotional arrangement of claim 1, wherein the promotional item includes one or more of a coupon, a rebate, a discount, medicinal indications and side effects, retailer information, manufacturer information, recipes and news stories.

9. The promotional arrangement of claim 1, wherein the promotional item is one of a coupon, a rebate, a discount, indications for the pharmaceutical product, information about the pharmaceutical product, a business reply card, retailer information and manufacturer information.

10. The promotional arrangement of claim 1, further comprising an additional promotional item corresponding to one or more of the pharmaceutical product, customer age, customer gender and customer ethnicity.

11. A method, comprising:
providing a plurality of pre-assembled pharmaceutical promotional arrangements, wherein the arrangements comprise a container having a first portion configured to receive a predetermined pharmaceutical product and a second portion housing a promotional item corresponding to the predetermined pharmaceutical product;
providing the plurality of pre-assembled pharmaceutical promotional arrangements to a user;
receiving a prescription corresponding to at least one indicator of the promotional arrangement; and
placing the prescribed pharmaceutical product into the promotional arrangement.

12. The method of claim 11, further comprising the steps of:
entering the prescription into a database, wherein the database is configured to determine if the prescribed drug meets at least one of a predetermined set of qualifying factors for the promotional items; and
displaying a message requiring use of the promotional arrangement if the prescribed drug meets at least one of these factors.

13. The method of claim 12, wherein the set qualifying factors includes the drug being prescribed, an age of a customer, a gender of the customer, and an ethnicity the customer.

14. The method of claim 11, further comprising the steps of:
logging information regarding dispensing of the pharmaceutical product in the promotional arrangement; and
proving the information to an advertiser of the promotional item.

15. The method of claim 11, further comprising the step of placing the prescribed pharmaceutical product in a container and inserting the container in the promotional arrangement.
